(19) United States
(12) Patent Application Publication
(10) Pub. No.: US 2026/0054130 A1
(43) Pub. Date: Feb. 26, 2026

(54) ARTIFICIAL INTELLIGENCE-ASSISTED EXERCISE AND REHABILITATION DEVICE

(71) Applicant: CHIH-YUNG HSU, TAINAN CITY (TW)

(72) Inventor: CHIH-YUNG HSU, TAINAN CITY (TW)

(21) Appl. No.: 18/925,296

(22) Filed: Oct. 24, 2024

(30) Foreign Application Priority Data
Aug. 21, 2024 (TW) 113209021

(51) Int. Cl. A63B 24/00; A63B 21/00

(52) U.S. Cl. CPC A63B 24/0062; A63B 21/4047; A63B 24/0075; A63B 2024/0065; A63B 2230/045; A63B 2230/405; A63B 2230/505

(57) ABSTRACT

An artificial intelligence-assisted exercise and rehabilitation device includes a frame; at least one mechanical arm, disposed on the frame, a free end of the mechanical arm having an operating part; and an artificial intelligence module, electrically connected to the mechanical arm. The artificial intelligence module automatically identifies a physiological feature of an operator and outputs a control program according to the physiological feature. The control program drives the mechanical arm for the operating part to move along a guidance path. The trajectory of the operator's exercise or rehabilitation exercise can be learned and recorded through artificial intelligence for comparative assessment of the exercise or rehabilitation effectiveness.

### FIELD OF THE INVENTION

The present invention relates to a device that can learn and record the trajectory of an operator's exercise or rehabilitation exercise through artificial intelligence for assessment of the exercise or rehabilitation effectiveness.

### BACKGROUND OF THE INVENTION

Taiwan Utility Model Publication No. M615005 discloses a joint rehabilitation machine, published on Aug. 1, 2021, comprises a base unit, an arm exercise device and a control unit. The base unit includes a base. The arm exercise device includes a pole unit extending vertically on the base, a drive unit on the pole unit, an arm carrier connected to the drive unit, and a hand exercise mechanism pivoted to the arm carrier. The drive unit drives the arm carrier and the hand exercise mechanism to rotate horizontally between a first rotation position and a second rotation position. The hand exercise mechanism is rotated up and down. The control unit is disposed in the base and electrically connected to the arm exercise device for controlling rotation of the arm carrier and the hand exercise mechanism between the first rotation position and the second rotation position and for controlling the hand exercise mechanism to rotate up and down.

The joint rehabilitation machine provided by the foregoing patent aims at the rehabilitation of the user's elbow joint. The scope of use is limited, making it difficult to achieve the rehabilitation effect of the upper and lower limbs.

Taiwan Utility Model Publication No. M451125 discloses an interactive mechanical arm device for upper limb rehabilitation, published Apr. 21, 2013, comprising a mechanical arm unit, a drive unit, and a control unit. The mechanical arm unit includes a shoulder joint module, an elbow joint module, and a wrist joint module. The control unit includes a human-machine operation module, an interface transmission module electrically connected to the human-machine operation module, and a drive module electrically connected to the interface transmission module and the drive unit. The human-machine operation module inputs several exercise trajectory programs for controlling the drive module to drive the drive unit and to further operate the shoulder joint module, the elbow joint module and the wrist joint module according to the exercise trajectory. This allows the user's upper limbs to do rehabilitation exercise through the traction of the mechanical arm unit.

The interactive mechanical arm device provided by the foregoing patent also aims at upper limb rehabilitation. It cannot achieve the rehabilitation effect of the upper and lower limbs of the whole body, cannot learn and record the user's exercise trajectory for comparison of progress or regression, and cannot determine whether the user's current posture meets the key points of rehabilitation. It is unable to appropriately guide the user to the correct exercise trajectory based on the set or learned exercise records. Therefore, it is not ideal for use.

### SUMMARY OF THE INVENTION

In view of the above-mentioned shortcomings, the present invention provides an artificial intelligence-assisted exercise and rehabilitation device, comprising a frame; at least one mechanical arm, disposed on the frame, a free end of the mechanical arm having an operating part; and an artificial intelligence module, electrically connected to the mechanical arm. The artificial intelligence module automatically identifies a physiological feature of an operator and outputs a control program according to the physiological feature. The control program drives the mechanical arm for the operating part to move along a guidance path.

The physiological feature is a physiological state feature of a human or animal.

The physiological feature includes one of a facial feature, a fingerprint feature, a palm print feature, an iris feature, a voice feature, a gait feature, a heart rhythm feature, a breathing feature and a body temperature feature or any combination thereof.

The artificial intelligence-assisted exercise and rehabilitation device further comprises a physiological feature detection module. The physiological feature detection module is in signal communication with the artificial intelligence module to capture the physiological feature for automatically identifying the operator's identity.

The physiological feature detection module includes a first detector and a second detector. The first detector is disposed on the frame for detecting one of the facial feature, the iris feature, the voice feature, the gait feature and the breathing feature or any combination thereof. The second detector is disposed on the operating part for detecting one of the fingerprint feature, the palm print feature, the heart rhythm feature and the body temperature feature or any combination thereof.

The first detector is a video capture unit. The second detector is a physiological state detection unit.

The artificial intelligence module further records an actual movement path of the operating part.

The artificial intelligence module performs a corrective action when a path deviation between the guidance path and the actual movement path exceeds a preset value.

The corrective action includes resetting the operating part to move along the guidance path from an origin, increasing an output power of the mechanical arm, and stopping movement of the mechanical arm.

The artificial intelligence-assisted exercise and rehabilitation device further comprises a display unit. The display unit is electrically connected to the artificial intelligence module.

The display unit displays one of the following information: the physiological feature, the actual movement path, the guidance path, the path deviation between the guidance path and the actual movement path, a historical record of the actual movement path, exercise effectiveness scores, exercise teaching information, exercise suggestion information, rehabilitation effectiveness scores, rehabilitation teaching information, and rehabilitation suggestion information.

The frame is one of a tabletop frame, a floor-standing frame and a wall-mounted frame.

The mechanical arm is a six-axis mechanical arm.

The mechanical arm includes a slide. The slide is movable relative to the frame.

Rehabilitation controlled by the artificial intelligence module includes passive rehabilitation or active rehabilitation.

The passive rehabilitation means that the mechanical arm generates a traction force on the operator's hands through the operating part, so that the operator's hands are pulled by the mechanical arm to move.

The active rehabilitation means that the mechanical arm generates an automatically adjustable resistance to the operator's hands through the operating part and does not pull the operator's hands to move.

According to the above technical features, the present invention has the following advantages:
1. The physiological feature detection module can automatically detect various physiological features of the operator to quickly confirm the identity of the operator, and the display unit displays the relevant information of the operator as a reference for exercise or rehabilitation.
2. The operator can choose passive or active rehabilitation based on the displayed information for rehabilitation.
3. The passive rehabilitation means that the two mechanical arms generate a traction force on the hands of the operator through the two operating parts, so that the hands of the operator are pulled by the mechanical arms to move along the guidance path for rehabilitation.
4. The active rehabilitation means that the two mechanical arms generate an automatically adjustable resistance to the hands of the operator through the two operating parts and do not pull the hands of the operator to move. The operator actively moves the two operating parts with both hands to overcome the resistance for rehabilitation.
5. After the exercise or rehabilitation is completed, the artificial intelligence module will compare the actual movement path completed by the operator with the set guidance path and calculate the path deviation resulting from the difference between the guidance path and the actual movement path for reference in the next rehabilitation.
6. The path deviation can be used to learn and record the trajectory of the operator's exercise or rehabilitation for comparative assessment of progress or regression.
7. The artificial intelligence module scores the exercise or rehabilitation effectiveness each time to determine whether the current posture of the operator meets the key points of exercise or rehabilitation and provides exercise or rehabilitation suggestion information.
8. Based on the learned exercise or rehabilitation records, the operator is appropriately guided to do correct exercise or rehabilitation.
9. The physiological feature of the operator is monitored at all times during the rehabilitation or exercise operation. Once the physiological state is abnormal, the movement of the mechanical arm will be stopped to halt the operation and ensure the safety of the operator.
10. When the artificial intelligence module monitors that the path deviation between the guidance path and the actual movement path exceeds a preset value, the artificial intelligence module will perform a corrective action. For example, the operating part is reset to move along the guidance path from the origin.
11. If the resistance generated by the mechanical arm is too less, the output power of the mechanical arm will be increased to increase the resistance of the exercise or rehabilitation.
12. If the resistance is so great that the operator cannot bear the load, the resistance will be reduced or the movement of the mechanical arm will be stopped immediately to halt the exercise or rehabilitation operation, thereby ensuring the safety of the operator in the exercise or rehabilitation process.
13. The frame may be a tabletop frame that can be mounted on a table, allowing convenient use by different operators.

### BRIEF DESCRIPTION OF THE DRAWINGS

FIG. 1 is a perspective view according to a first embodiment of the present invention;

FIG. 2 is a side view according to the first embodiment of the present invention;

FIG. 3 is a block diagram showing the configuration of the first embodiment of the present invention;

FIG. 4 is a schematic view according to the first embodiment of the present invention when in use;

FIG. 5 is a schematic view showing the action of the first embodiment of the present invention;

FIG. 6 is another schematic view showing the action of the first embodiment of the present invention; and

FIG. 7 is a perspective view according to a second embodiment of the present invention.

### DESCRIPTION OF THE PREFERRED EMBODIMENTS

Embodiments of the present invention will now be described, by way of example only, with reference to the accompanying drawings.

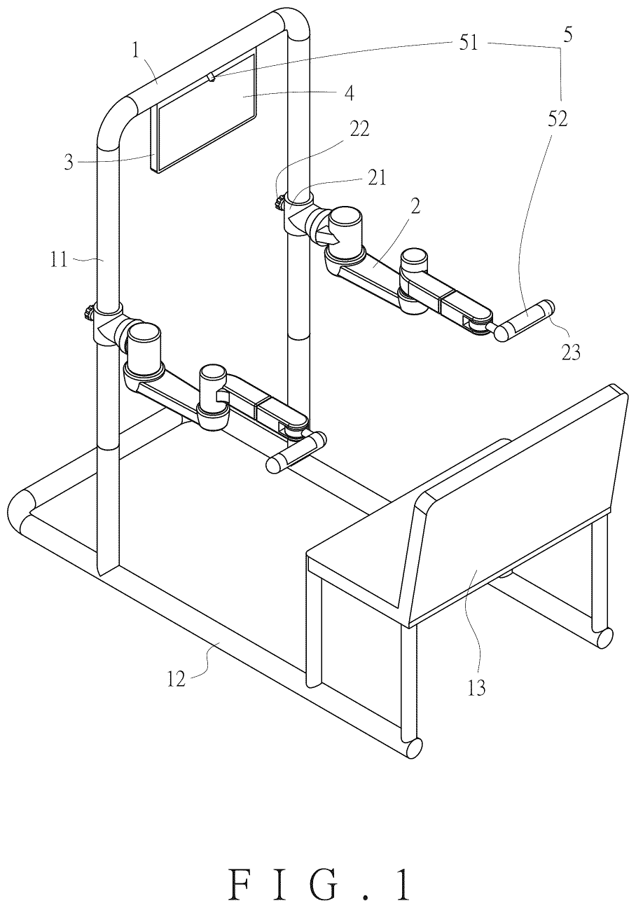

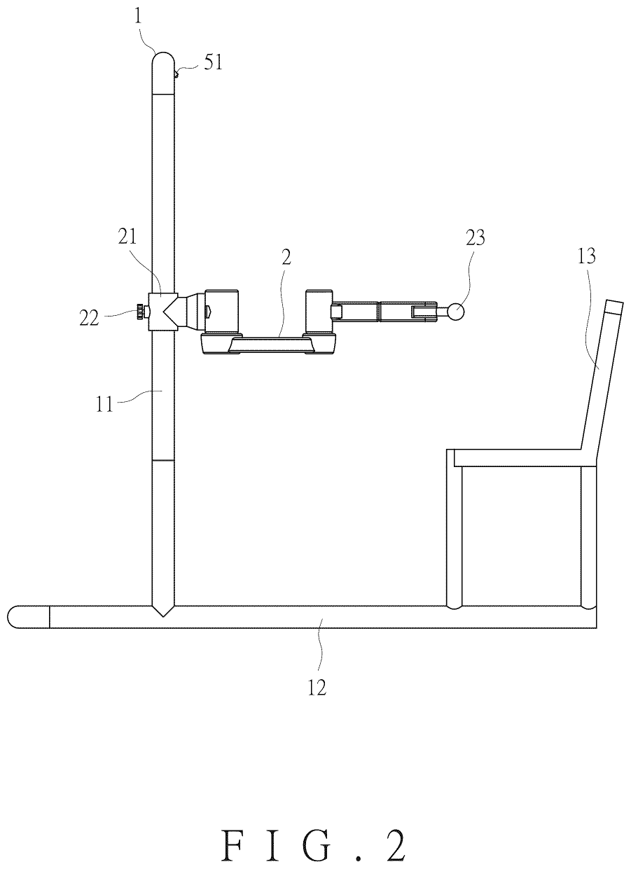

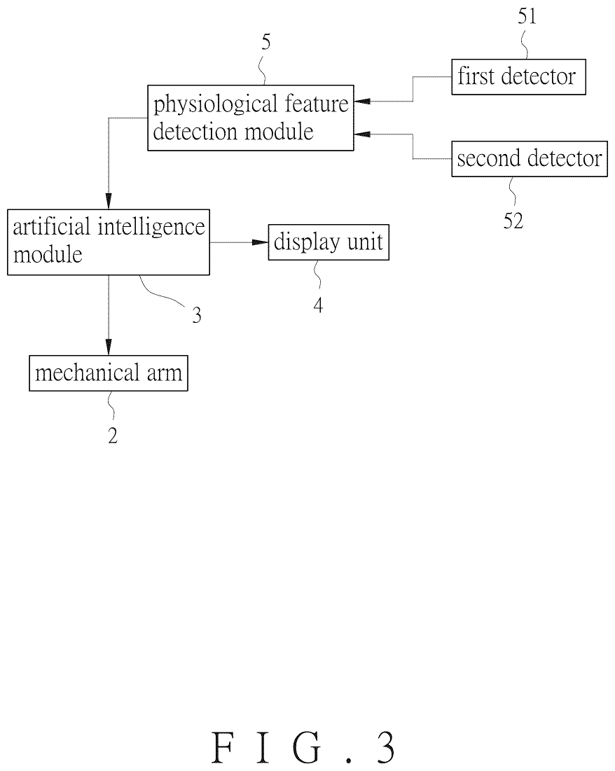

As shown in FIG. 1, FIG. 2 and FIG. 3, the present invention discloses an artificial intelligence-assisted exercise and rehabilitation device, comprising a frame 1, at least one mechanical arm 2, an artificial intelligence module 3, a display unit 4 and a physiological feature detection module 5.

The frame 1 is a reverse U-shaped upright frame. The frame 1 has an upright pole 11 on either side. The frame 1 is a floor-standing frame or a wall-mounted frame (not shown in the figures). Abase 12 is connected to the bottom of the floor-standing frame. A seat 13 is provided at one end of the base 12 for use. The wall-mounted frame is secured to the wall for use.

The mechanical arm 2 is disposed on the frame 1. In this embodiment of the present invention, two mechanical arms 2 are provided on the frame 1. Preferably, the two mechanical arms 2 are six-axis mechanical arms capable of translation and rotation along three coordinate axes that are perpendicular to one another, namely, a longitudinal axis, a horizontal axis and a vertical axis, providing six degrees of freedom in a space. One end of the mechanical arm 2 has a slide 21. The slides 21 of the two mechanical arms 2 are fitted on the two vertical poles 11 of the frame 1, thereby driving the mechanical arms 2 to move on the vertical poles 11 relative to the frame 1. A fastening bolt 22 is provided on the slide 21. By fastening the fastening bolt 22, the slide 21 may be secured at any position on the pole 11, so that it can be manually adjusted to suit the height, arm length or usage habits of different operators. The slide 21 in this embodiment of the present invention may be set to slide automatically for adjusting any position secured on the pole 11. As to the self-adjustment, the slide 21 may be driven by a drive motor to move automatically (not shown in the figure). Both can be implemented in the embodiments of the present invention. The other end of the mechanical arm 2 is a free end. The free end has an operating part 23. The operating part 23 is a handle or a grip ring for the operator to hold with both hands for exercise or rehabilitation training of the operator's upper limbs. The operating part 23 may be a strap used for binding the feet of the operator for exercise or rehabilitation training of the operator's lower limbs. In addition to the above-mentioned six-axis mechanical arm, other types of mechanical arms are also feasible embodiments of the present invention.

The artificial intelligence module 3 is disposed on the frame 1. The artificial intelligence module 3 is electrically connected to the mechanical arm 2. The artificial intelligence module 3 automatically identifies a physiological feature and identity of the operator and outputs a control program according to the physiological feature. The control program drives the mechanical arm 2 for the operating part 23 to move along a guidance path. The physiological feature is a physiological state feature of a human or animal. The physiological feature includes one of a facial feature, a fingerprint feature, a palm print feature, an iris feature, a voice feature, a gait feature, a heart rhythm feature, a breathing feature and a body temperature feature, or any combination thereof. The artificial intelligence module 3 further records an actual movement path of the operating part 23. The artificial intelligence module 3 performs a corrective action when the path deviation between the guidance path and the actual movement path exceeds a preset value. The corrective action includes resetting the operating part to move along the guidance path from the origin, increasing the output power of the mechanical arm, and stopping the movement of the mechanical arm. The rotational speed of the motor, torque and other parameters of each joint of the mechanical arm 2 of the present invention can be recorded as reference data for controlling the mechanical arm 2 in the future.

The display unit 4 is disposed on the frame 1. The display unit 4 is electrically connected to the artificial intelligence module 3. The display unit 4 is configured to display one of the following information: the physiological feature, the actual movement path, the guidance path, the path deviation between the guidance path and the actual movement path, the historical record of the actual movement path, exercise effectiveness scores, exercise teaching information, exercise suggestion information, rehabilitation effectiveness scores, rehabilitation teaching information, and rehabilitation suggestion information.

The physiological feature detection module 5 is disposed on the frame 1 and the operating part 23. The physiological feature detection module 5 is in signal communication with the artificial intelligence module 3, thereby capturing the physiological feature of the operator for the artificial intelligence module 3 to automatically identify the identity of the operator. The physiological feature detection module 5 includes a first detector 51 and a second detector 52. The first detector 51 is a video capture unit. The video capture unit is disposed on the top of the frame 1 for detecting the physiological feature of the operator, such as the facial feature, the iris feature, the voice feature, the gait feature and the breathing feature. The second detector 52 is a physiological state detection unit. The physiological state detection unit is disposed on the operating part 23 for detecting the physiological feature of the operator, such as the fingerprint feature, the palm print feature, the heart rhythm feature and the body temperature feature.

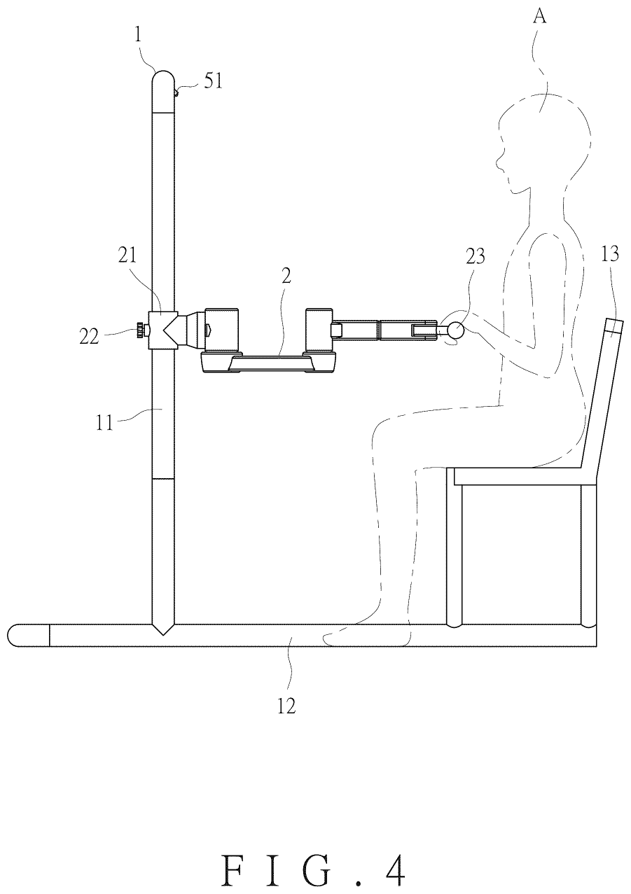

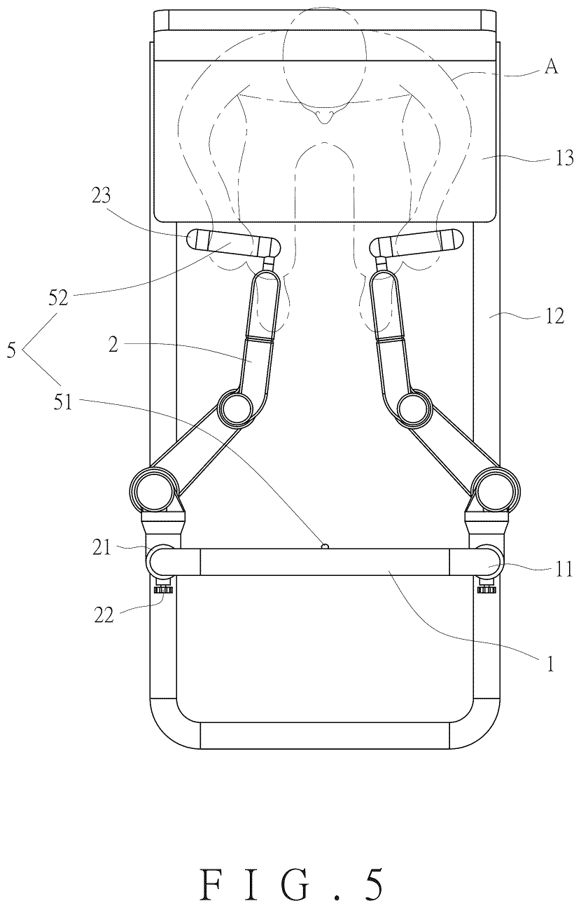

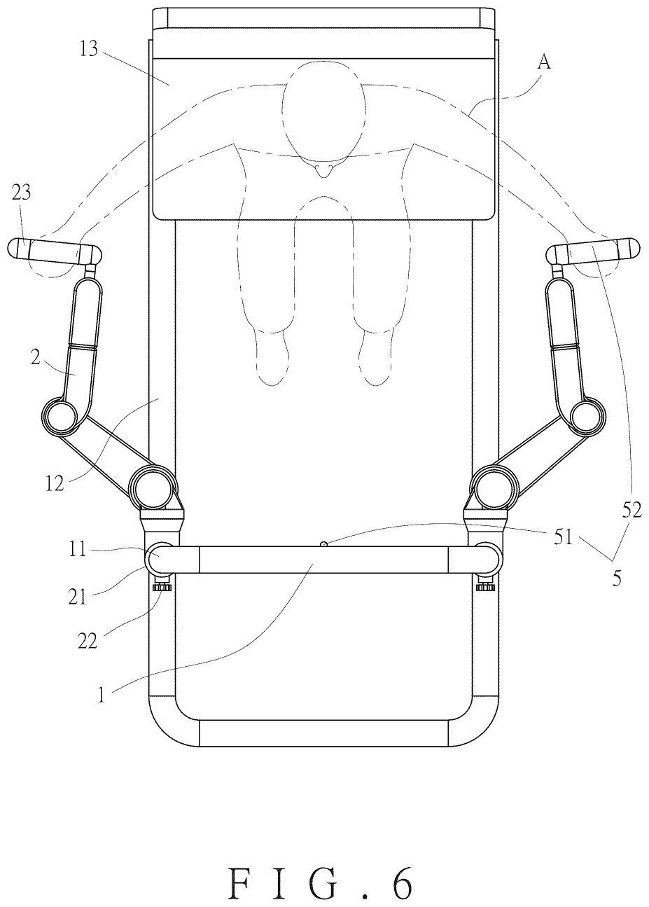

When in use, as shown in FIG. 4, FIG. 5 and FIG. 6, an operator A sits on the seat 13, and then both hands of the operator A hold the operating parts 23 of the mechanical arms 2 respectively. By activating the artificial intelligence module 3 and the physiological feature detection module 5, either the first detector 51 or the second detector 52 is first controlled to be activated individually or both the first detector 51 and the second detector 52 are activated together. The first detector 51 is configured for detecting the physiological feature of the operator A, such as one of the facial feature, the iris feature, the voice feature, the gait feature and the breathing feature or any combination thereof. The second detector 52 is configured for detecting the physiological feature of the operator A, such as the fingerprint feature, the palm print feature, the heart rhythm feature and the body temperature feature. The first detector 51 and the second detector 52 transmit the detected physiological features to the artificial intelligence module 3 for automatically identifying the identity of the operator A. When the identity of the operator A is identified and after the identity of the operator A is correct, the display unit 4 will display the information related to the exercise or rehabilitation of the operator A. The information includes the physiological feature, the actual movement path, the guidance path, the path deviation between the guidance path and the actual movement path, the historical record of the actual movement path, exercise effectiveness scores, exercise teaching information, exercise suggestion information, rehabilitation effectiveness scores, rehabilitation teaching information, and rehabilitation suggestion information. In the case of a rehabilitation operation, for example, the operator A chooses whether the rehabilitation operation is passive or active based on the above information. The passive rehabilitation means that the two mechanical arms 2 generate a traction force on the hands of the operator A through the two operating parts 23, so that the hands of the operator A are pulled by the mechanical arms 2 to move along the guidance path for rehabilitation. When the rehabilitation is completed, the artificial intelligence module 3 will score the rehabilitation effectiveness and provide rehabilitation suggestion information.

The active rehabilitation means that the two mechanical arms 2 generate an automatically adjustable resistance to the hands of the operator A through the two operating parts 23 and do not pull the hands of the operator A to move. The operator A actively moves the two operating parts 23 with both hands, and the two mechanical arms 2 follow the movement of the hands of the operator A. The operator A operates the two operating parts 23 with both hands to drive the two mechanical arms 2 to move according to the guidance path displayed on the display unit 4 to overcome the resistance and complete the actual movement path. After the rehabilitation is completed, the artificial intelligence module 3 will compare the actual movement path completed by the operator A with the set guidance path and calculate the path deviation resulting from the difference between the guidance path and the actual movement path for reference in the next rehabilitation. The path deviation can be used to learn and record the trajectory of the operator's rehabilitation and exercise for comparative assessment of progress or regression. Besides, the artificial intelligence module 3 scores the rehabilitation effectiveness for this rehabilitation to determine whether the current posture of the operator A meets the key points of rehabilitation, and provide rehabilitation suggestion information. Furthermore, based on the learned rehabilitation records, the operator A is appropriately guided to do correct rehabilitation and exercise.

Regardless of whether passive or active rehabilitation is selected, the physiological feature of the operator A is monitored at all times during the rehabilitation operation. Once the physiological state is abnormal, the movement of the mechanical arm 2 will be stopped to halt the rehabilitation operation and ensure the safety of the operator A, or when the artificial intelligence module 3 monitors that the path deviation between the guidance path and the actual movement path exceeds a preset value, the artificial intelligence module 3 will perform a corrective action. For example, on the three coordinate axes that are perpendicular to one another, namely, a longitudinal axis, a horizontal axis and a vertical axis, if the actual movement path of the operator A deviates from the guidance path by more than 1 centimeter, the deviation is deemed to exceed the preset value. The corrective action includes resetting the operating part 23 to move along the guidance path from the origin. If the resistance generated by the mechanical arm 2 is too less, the output power of the mechanical arm 2 will be increased to increase the resistance of the rehabilitation. If the resistance is so great that the operator A cannot bear the load, the resistance will be reduced or the movement of the mechanical arm will be stopped immediately to halt the rehabilitation operation, thereby ensuring the safety of the operator A in the rehabilitation process.

The above-mentioned embodiments focus on rehabilitation operations, but the present invention has the same effect when it is used for exercise and fitness training.

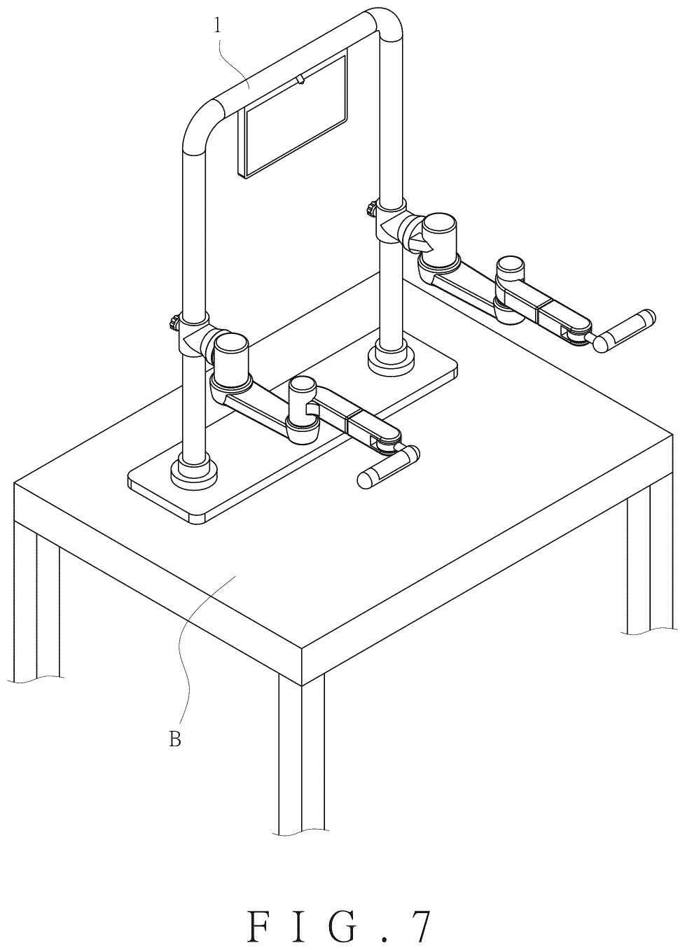

FIG. 7 illustrates a second embodiment of the present invention. The difference between the second embodiment of the present invention and the first embodiment described above is that the frame 1 of the second embodiment is a tabletop frame that can be mounted on a table B, allowing convenient use by different operators.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An artificial intelligence-assisted exercise and rehabilitation device, comprising:
a frame;
at least one mechanical arm, disposed on the frame, a free end of the mechanical arm having an operating part;
an artificial intelligence module, electrically connected to the mechanical arm;
wherein the artificial intelligence module automatically identifies a physiological feature of an operator and outputs a control program according to the physiological feature, and the control program drives the mechanical arm for the operating part to move along a guidance path.

2. The artificial intelligence-assisted exercise and rehabilitation device as claimed in claim 1, wherein the physiological feature is a physiological state feature of a human or animal.

3. The artificial intelligence-assisted exercise and rehabilitation device as claimed in claim 2, wherein the physiological feature includes one of a facial feature, a fingerprint feature, a palm print feature, an iris feature, a voice feature, a gait feature, a heart rhythm feature, a breathing feature and a body temperature feature or any combination thereof.

4. The artificial intelligence-assisted exercise and rehabilitation device as claimed in claim 3, further comprising a physiological feature detection module, the physiological feature detection module being in signal communication with the artificial intelligence module to capture the physiological feature for automatically identifying the operator's identity.

5. The artificial intelligence-assisted exercise and rehabilitation device as claimed in claim 4, wherein the physiological feature detection module includes a first detector and a second detector, the first detector is disposed on the frame for detecting one of the facial feature, the iris feature, the voice feature, the gait feature and the breathing feature or any combination thereof, and the second detector is disposed on the operating part for detecting one of the fingerprint feature, the palm print feature, the heart rhythm feature and the body temperature feature or any combination thereof.

6. The artificial intelligence-assisted exercise and rehabilitation device as claimed in claim 5, wherein the first detector is a video capture unit, and the second detector is a physiological state detection unit.

7. The artificial intelligence-assisted exercise and rehabilitation device as claimed in claim 1, wherein the artificial intelligence module further records an actual movement path of the operating part.

8. The artificial intelligence-assisted exercise and rehabilitation device as claimed in claim 7, wherein the artificial intelligence module performs a corrective action when a path deviation between the guidance path and the actual movement path exceeds a preset value.

9. The artificial intelligence-assisted exercise and rehabilitation device as claimed in claim 8, wherein the corrective action includes resetting the operating part to move along the guidance path from an origin, increasing an output power of the mechanical arm, and stopping movement of the mechanical arm.

10. The artificial intelligence-assisted exercise and rehabilitation device as claimed in claim 7, further comprising a display unit, the display unit being electrically connected to the artificial intelligence module.

11. The artificial intelligence-assisted exercise and rehabilitation device as claimed in claim 10, wherein the display unit displays one of the following information: the physiological feature, the actual movement path, the guidance path, the path deviation between the guidance path and the actual movement path, a historical record of the actual movement path, exercise effectiveness scores, exercise teaching information, exercise suggestion information, rehabilitation effectiveness scores, rehabilitation teaching information, and rehabilitation suggestion information.

12. The artificial intelligence-assisted exercise and rehabilitation device as claimed in claim 1, wherein the frame is one of a tabletop frame, a floor-standing frame and a wall-mounted frame.

13. The artificial intelligence-assisted exercise and rehabilitation device as claimed in claim 1, wherein the mechanical arm is a six-axis mechanical arm.

14. The artificial intelligence-assisted exercise and rehabilitation device as claimed in claim 1, wherein the mechanical arm includes a slide, and the slide is movable relative to the frame.

15. The artificial intelligence-assisted exercise and rehabilitation device as claimed in claim 1, wherein rehabilitation controlled by the artificial intelligence module includes passive rehabilitation or active rehabilitation.

16. The artificial intelligence-assisted exercise and rehabilitation device as claimed in claim 15, wherein the passive rehabilitation means that the mechanical arm generates a traction force on the operator's hands through the operating part, so that the operator's hands are pulled by the mechanical arm to move.

17. The artificial intelligence-assisted exercise and rehabilitation device as claimed in claim 15, wherein the active rehabilitation means that the mechanical arm generates an automatically adjustable resistance to the operator's hands through the operating part and does not pull the operator's hands to move.
